(19) United States
(12) Patent Application Publication
(10) Pub. No.: US 2014/0253737 A1
(43) Pub. Date: Sep. 11, 2014

(54) SYSTEM AND METHOD OF TRACKING AN OBJECT IN AN IMAGE CAPTURED BY A MOVING DEVICE

(71) Applicant: Yitzchak Kempinski, Geva Binyamin (IL)

(72) Inventor: Yitzchak Kempinski, Geva Binyamin (IL)

(21) Appl. No.: 14/342,791

(22) PCT Filed: Sep. 6, 2012
(86) PCT No.: PCT/IL12/50349

§ 371 Date: May 29, 2014

Related U.S. Application Data
(60) Provisional application No. 61/531,880, filed on Sep. 7, 2011.

(51) Int. Cl. G06T 7/00; H04N 5/232

(52) U.S. Cl. CPC G06T 7/004; H04N 5/232
USPC 348/169

(57) ABSTRACT

A system and method for calculating an expected change in a position of an object in a series of images resulting from a movement of an imager capturing such series of images, and comparing an actual position of such object in an image captured after such movement to determine if, and to what extent, a change in position of the object in such later captured image resulted from a change of a position in space of the object.

### FIELD OF THE INVENTION

The present invention relates to tracking an object in a series of images. More particularly, the present invention relates to tracking an object when the tracking device is portable, moving or unstable.

### BACKGROUND OF THE INVENTION

Many devices are capable of acquiring successive images and of extracting specific data from the images. For example, modern mobile phones and smart phones often include a camera that may be used to acquire single images or a series of video frames or images. Such devices are often provided with processing capability that may be utilized to analyze acquired images or video frames, or with a communication capability that may be utilized to send acquired images or frames to a remote facility for processing.

Successive images of a single object may be analyzed in order to track an imaged object. For example, results of tracking the object may be utilized by an application or program that is running on the device.

### SUMMARY OF THE INVENTION

Embodiments of the invention may include a method of identifying a cause of a change of a location of an object in a series of images captured with an imager where such method includes detecting a position of the object in a first image, detecting a movement of the imager, calculating from the detected movement of the imager, an expected position of the object in a second or subsequent image; and detecting a second position of the object in such second or subsequent of image as being the same, similar or different from the expected position.

In some embodiments, the method may include comparing the expected position of the object to the detected position of the object in the second image, and calculating a difference between the detected second position and the expected position. In some embodiments, the method may include calculating a movement in space of the object between a time of the capture of the first image and a time of capture of the second image. In some embodiments, the method may include moving a search window in the second image in a direction of the detected movement of the imager or to an area matching or surrounding the expected position or location of the object in the image. In some embodiments, the method may include calculating the expected position from the detected movement and from a movement of the object in a series of images prior to the first image. In some embodiments, the method may include receiving a signal from a motion sensor associated with the imager. In some embodiments, the method may include calculating the expected position from detected movement along Cartesian coordinates and along Eular angles. In some embodiments, the method may include detecting the position of the object in the second image, where such second image is captured after the detecting of the movement of the imager.

In some embodiments, the method may include initiating an identification process of the object in the second image. In some embodiments, the method may include detecting a magnitude of the movement of the imager that is above a pre-defined threshold. In some embodiments, the method may include capturing an image of an eye of a user of the imager capturing the series of images.

Embodiments of the invention may include a system that has an imager, to capture a series of images, a movement sensor to detected a direction and magnitude of a movement of the imager, a processor configured to identify a position of an object in a first image, to accept a signal from the sensor including a direction and magnitude of a movement of the imager; and to calculate from the signal, an expected position of the object in a second image.

Embodiments of the invention may include a method of detecting a movement of a body part, such as an eye, head, finger or a portion of such body part, in an image captured by an operator of the imager which is capturing the image. Such method may include capturing a series of images of body part of an operator of the imager that is capturing the images, detecting in a first image a location of the body part, detecting a movement of the imager, calculating, from such movement of the imager, an expected position of the body part in a second image, and calculating from an actual position of the body part in the second image, a movement of the body part in the period between a capture of the first image and a capture of the second image. In some embodiment, such method may accepting a signal from a motion sensor connected to the imager of a movement of the imager, in excess of a pre-defined threshold.

### BRIEF DESCRIPTION OF THE DRAWINGS

In order to better understand the invention, and appreciate its practical applications, the following figures are provided and referenced hereafter. It should be noted that the figures are given as examples only and in no way limit the scope of the invention.

FIG. 1 is a schematic drawing of a tracking system, in accordance with some embodiments of the invention;

FIG. 2 schematically illustrates tracking of an object, in accordance with some embodiments of the invention;

FIG. 3 is a flowchart of a tracking method, in accordance with some embodiments of the invention; and

FIG. 4 is a flowchart of a method of identifying a source of a change of a position of an object in a series of images, in accordance with an embodiment of the invention.

### DETAILED DESCRIPTION OF EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

In accordance with embodiments of the present invention, a tracking device includes an imaging device (e.g. a digital camera or video camera, or a camera that is incorporated into a cell phone, smart phone, handheld computer or other portable device). The imaging device is used to track an object. For example, the tracked object may include a head, finger eye or other body part or part of a head, eye or finger or other body part, of a user who is also typically operating the device and its camera or imager. Tracked eye or head movements may be interpreted to ascertain a point (e.g. of a displayed user interface, or of other graphics or text) at which the eye is looking or to activate or trigger the activation of a function of the device. Tracked movement of other body parts may likewise be used as triggers for activation of certain functions.

The imaging device may successively acquire one or more images or frames, some or all of which may include an image of the object (henceforth, object image). For example, an acquired frame may include digital representations of pixels of the object image.

A processing capability that is associated with the imaging device (e.g. incorporated into the imaging device or tracking device, or in communication with the imaging device or tracking device) may analyze an acquired frame. The analysis may enable identifying the image of the object in the object frame. A position of the identified object image may be determined relative to the frame, corresponding to a position of the imaged object relative to a field of view of the imaging device or to for example edges of the captured image. The position of the imaged object relative to the field of view may be referred to as an apparent position of the imaged object in or relative to the image. For example, the apparent position of the object may be expressible as an angular separation between the object (e.g. a line of sight from the imaging device to the object) and an axis of the imaging device (e.g. a normal to an image plane of the imaging device, e.g. defining a center of the imaging device's (angular) field of view). A position or location of an object in an image may also be defined relative to the pixels or locations of the pixels occupied by the object in the image. If the imaging device includes, or has access to, a range-finding device or capability, a position of the object relative to the imaging device may be determined.

A position or orientation, or a change in position or orientation, of the imaging device (or of a vehicle, cart, or other moving object on which the imaging device is mounted) may be determined concurrently with tracking of the object by the imaging device. Measurements by appropriate position, orientation, velocity, or acceleration sensors, herein referred to collectively as movement or motion sensors, may be analyzed to yield a motion, or a change in a position or orientation, of the imaging device, and a time of such change may be associated with one or more images that are captured before, during and after the change or movement.

For example, data from a gyroscope, compass, tilt sensor, or other device for measuring an orientation, may detect a motion in the form of a rotation or change in orientation of the imaging device. Acceleration, velocity, or position data from a linear accelerometer, a speedometer, or a locator (e.g. via terrestrial triangulation or via the Global Positioning System (GPS)), or other position or motion measurement device, may be analyzed to yield a motion in the form of a linear velocity or change in position of the imaging device.

In accordance with some embodiments of the invention, the determined motion of the imaging device may be used to assist in analysis of tracking or in a determination of whether a change in a position of an object in a series of images resulted from a movement of the object in space or from a movement of the imager, or from a combination of the two. For example, if the imaging device is moving, tracking by the imaging device the object may yield ambiguous results. Tracking by the imaging device results in a measured apparent motion of the object relative to the field of view of the imaging device. Such an apparent motion may be caused by a motion or movement of the field of view (e.g. due to motion of the imaging device), or by true motion of the object (e.g. relative to its surroundings, to another fixed frame of reference or its position in space), or may be caused by a combination of the two.

The apparent motion of the object may be analyzed in light of a measured motion of the imaging device to yield a less ambiguous result. For example, calculation (e.g. that includes vector addition of a measured motion of the imaging device to a tracked apparent motion of the object) may yield a true motion of the object as the cause of the movement of the object in the image. (In the absence of a range detector, the calculated true motion may be limited to a motion that is locally perpendicular to a line of sight from the imaging device to the object. Motion along the line of sight may be derivable from a change in apparent size of the object.)

In some embodiments, the detected motion of the imaging device may be utilized to facilitate tracking by the imaging device and to compensate for a change in the position of the object in the image. The detected or determined motion of the imaging device and a previously calculated (or assumed) true motion of the object may be used to predict or estimate (e.g. by vector subtraction of measured motion of the field of view of the imaging device from the true motion) an expected position of the object image in a subsequently acquired frame. Knowledge of the expected position may be utilized to facilitate tracking of the object or a determination of a movement in space of the object.

For example, predicting the expected position of the object may be utilized to determine a region of an acquired frame (corresponding to a region of the field of view of the imaging device, or of search window) in which to search for the object image. Limiting a search for the object image to that search region of the frame may enable locating the object image in less time than would be required for locating the object image in the full frame. Expedited detection may result in increased reliability of the tracking. For example, expedited detection may reduce the frequency of occasions when tracking of the object is temporarily interrupted due to failure to locate the object in a frame (e.g., prior to acquisition of the next frame).

The limited search region may be selected on the basis of an assumed or previously determined motion of the object. For example, the object may be assumed to be at rest (e.g. for a slowly moving object that is imaged frequently), or to be continuing to move with a previously determined motion, direction and velocity.

In some embodiments, the motion detector may be utilized to detect that a large motion (e.g. characterized by a rotation or linear acceleration greater than, or whose rate of change is greater than, a threshold value) has occurred. In this case, the value of the measured motion may not be utilized in any calculations except to compare the measured value with a predetermined threshold or range.

For example, in the absence of a detected large motion (e.g. rotation, change in rotation, or linear acceleration), tracking of the object by the imaging device may continue on the assumption that a tracked apparent motion of the object is approximately equal to the true motion of the object in space (or that a position or orientation of the field of view is changing at a constant rate). Tracking of the object (e.g. searching for the object image) in subsequent frames may proceed on the basis of the assumption that the motion of the object in the prior frame will continue within some range of variation.

When a large motion of the imaging device is detected, tracking may be stopped or ignored for the frames captured at the time that the motion or movement of the imager is detected, and may be reinitialized on the assumption that the object will need to be re-identified in the image or that an identification process will need to be re-initiated to find the object after the imager's movement. The object image may then be searched for in the entire frame, or in a search region with an increased size where such size may be elongated or increased in a direction of the motion or in a direction that takes into account the movement of the imager. In some embodiments, search window may be moved to an expected position of the object after taking into account the movement of the imager. Once the object image is found (e.g. in a single frame, or in two or more successive frames) and the object tracked, tracking may continue on the assumption of a motionless (or predictably moving) field of view.

In some embodiments, a change in location or position of an object in an image may be detected in or between one or more frames. If such change is detected when or concurrent with a detection of a movement of the imager above a threshold, such detected change in the location of the object, which might would otherwise have been interpreted as a movement of the object in space, may be ignored, or interpreted not as a movement of the object in space. In such event, a function that would have been triggered upon a movement of the object in space may be cancelled or not implemented since the change in position will be attributed to the movement of the imager. Similarly, if a change in a location or position or an object in an image is equal or similar to the expected affect of a detected movement of the imager on the position of the object in the frame, such change in position of the object in the image may be ignored or not used to trigger a function or as part of a calculation, since the change in position of the object in the image may be attributed to a concurrent detected movement of the imager.

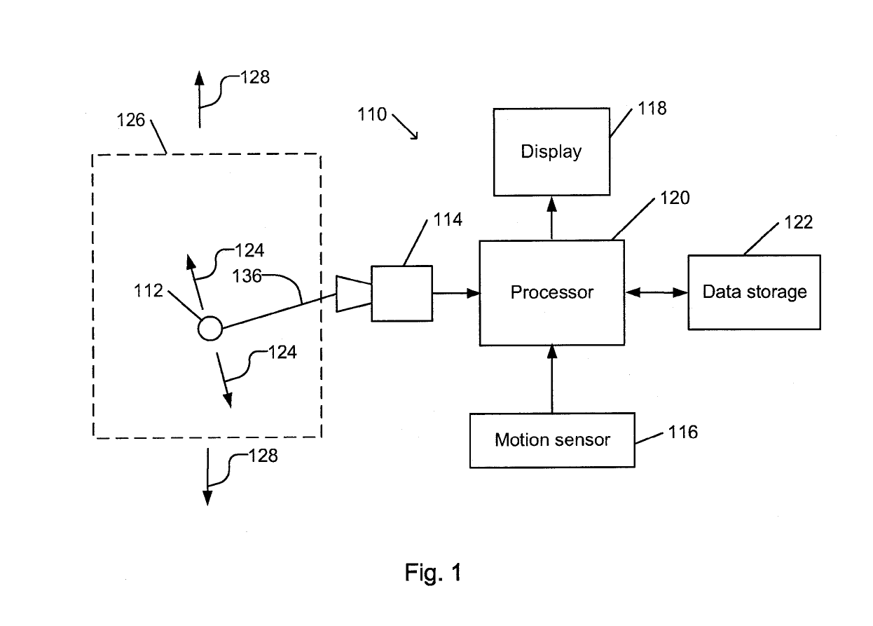

FIG. 1 is a schematic drawing of a tracking system, in accordance with some embodiments of the present invention.

Tracking device 100 may be operated to track an object 102. Tracking device 100 includes or is connected to imaging device 104. Object 102 may be imaged by imaging device or imager 104 when object 102 is located within field of view 106 of imaging device 104. Translational or rotational motion of tracking device 100 (or of imaging device 104) may cause a motion or change in field of view 106. Possible motion of field of view 106 is indicated by arrows 108 (henceforth field-of-view motion 108).

Tracking device 100 may be configured to track a motion of object 102. In the absence of range data of object 102 from imager 104, tracking of object 102 may be limited to a component of motion of object 102 that is substantially perpendicular to line of sight 136 between imaging device 104 and object 102. The tracked motion of object 102 is indicated by arrows 124 (henceforth, object motion 124).

In some embodiments, tracking device 100 may include a rangefinder (e.g. laser or other optical, radar, sonic), or range data may be determined from image data for from an image of object 102. For example, range data may be extracted from an optical focusing component of imaging device 104. In some embodiments, range information may be extracted from image data that is acquired by imaging device 104. For example, a change in size of an image of object 102 may be analyzed in order to determine a change in distance of object 102 from imaging device 104. Imaging of object 102 together with one or more fixed or distant objects may enable extracting a distance of object 102 from imaging device 104 using a parallax calculation or other comparison.

Image data that is acquired by imaging device 104 may be communicated to processor 120. For example, processor 120 may include one or more processing devices that are associated with imaging device 104 (e.g. when imaging device 104 includes a camera of a mobile telephone, smartphone, or portable computer, and an object includes a position of an eye of a user holding such telephone or mobile device). One or more components of processor 120 may be incorporated in a device that communicates (e.g. via communications channel or network) with imaging device 104 or with tracking device 100 (e.g. a remote computer or processor).

Device 100 may include one or more motion sensors 116. For example, a motion sensor 116 may be incorporated into or associated with processor 120, imaging device 104, or tracking device 100. A motion sensor 116 may be incorporated into a vehicle, housing or other platform by which device 100 is carried, or to which tracking device 100 is mounted or attached. Motion sensor 116 may include a position measuring device (e.g. that cooperates with one or more external devices or systems at known locations—e.g. GPS, or other triangulation, altimeter), a speed measuring device (e.g. speedometer, or positioning device that is successively read at known intervals), an accelerometer, an orientation measuring device (e.g. gyroscope, compass, tilt sensor), or a device that measures a rotation rate (e.g. gyroscope). Motion-related data that is acquired by motion sensor 116 may be communicated to processor 120.

Data from a motion sensor 116 may be processed, e.g. by processor 120, so as to improve accuracy or reduce noise of the sensor data. For example, a low pass filter may be applied to reduce or eliminate random or high-frequency noise or disturbances (e.g. of gyroscope data). Sensor data from several motion sensors 116 may be combined (e.g. averaged or by application of a fusion algorithm such as a Kalman filter) in order to increase the accuracy of the motion measurement.

Processor 120 may be configured to operate in accordance with programmed instructions. Programmed instructions may include instructions for executing a tracking method as described herein. Programmed instructions may include instructions for executing at least one other application. The other application may be executed in accordance with a result of execution of tracking method.

Processor 120 may communicate with data storage unit 122. Data storage unit 122 includes one or more volatile or non-volatile data storage devices. Data storage unit 122 may be used to store programmed instructions for operation of processor 120, image data that is generated by imaging device 104, motion-related data that is generated by motion sensor 116, or results of calculations or other results that are generated by processor 120.

In some embodiments, processor 120 may communicate with a display 118. Display 118 may included a display screen or control panel for displaying graphics, text, or other visible content. For example, processor 120 may operate display 118 to display a graphical user interface. A motion of an object 102 that is tracked by tracking device 100 may be interpreted by processor 120 as a selection of one or more objects of the displayed graphical user interface. Such tracked objects may include, for example, a finger, head, eye, or other part or attachment to a body such as a body of a user or operator of device 100.

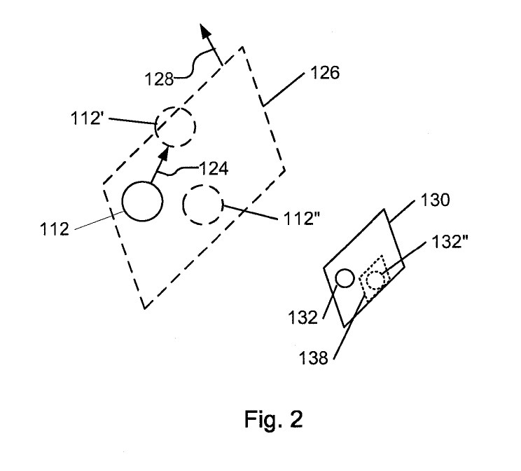

FIG. 2 schematically illustrates tracking of an object, in accordance with an embodiment of the present invention. Reference is also made to components shown in FIG. 1.

Field of view 126 is imaged by imaging device 104 to form a frame 130. For example, frame 130 may include a digital representation of grayscale or color data of an image of field of view 126 that is formed by focusing optics of imaging device 104 on an imaging plane of imaging device 104.

When object 102 is located within field of view 126, frame 130 includes object image 132 of object 102. (For simplicity, object image 132 is shown in FIG. 2 as located at the same relative position within frame 130 as is object 102 within field of view 126. However, in a typical frame 130, relative positions of two object images in one or both dimensions of frame 130 are inverted with respect to corresponding relative positions of the two imaged objects in field of view 126.)

An object 102 moves with object motion 124 (e.g. a velocity, or a projection of a velocity, of object 102). As a result, at a later time, object 102 moves to object position 112′. Concurrently with object motion 124, field of view 126 may move with field-of-view motion 128 (e.g. a velocity, or a projection into a plane of a velocity, of field of view 126). Thus, at the later time, due to the combination of object motion 124 and of field-of-view motion 128 (e.g. a vector subtraction of field-of-view motion 128 from object motion 124), object 102 appears to have moved to apparent object position 102″. As a result, object image 132 appears to have moved within frame 130 to object image position 132″.

In the absence of a motion sensor 116, tracking of object 102 would proceed without knowledge of field-of-view motion 128. Thus, tracking of object 102 in the presence of field-of-view motion 128 may require significantly more time or processing resources than would be required in the absence of field-of-view motion 128. For example, if object motion 124 were previously detected, at the later time object 102 would be expected to appear to be at object position 112′. Since object 102 would actually appear to be at apparent object position 112″ (corresponding to object image position 132″ in frame 130), tracking of object 102 could be interrupted unexpectedly. Renewed locating of object image position 132″ within frame 130 could be excessively time consuming (thus leading to further interruption of tracking of object 102). In the absence of knowledge of field-of-view motion 128, an apparent tracked motion of object image 132 (e.g. to object image position 132″) could be mistaken for an actual motion (e.g. object motion 124) of object 102.

In accordance with some embodiments of the present invention, a processor 120 may, on the basis of motion data from a motion sensor 116, calculate field-of-view motion 128. Knowledge of field-of-view motion 128 may be utilized to facilitate tracking of object 102 or of a determination that, or the extent to which, object 102 actually moved in space.

For example, knowledge of field-of-view motion 128 may be utilized to extract or approximate object motion 124 from tracking of an object 102 concurrent with motion of field of view 126 (e.g. due to motion of imaging device 104). An initial, raw, or uncorrected value of an apparent motion of object 102 within field of view 126 (e.g. to apparent object position 112″) may be derived from motion of object image 132 within frame 130 (e.g. to object image position 132″). Accurate knowledge of field-of-view motion 128 may be derived from data acquired from motion sensor 116. A correction based on the knowledge of field-of-view motion 128 may be applied to the uncorrected value of the apparent motion (e.g. vector addition of field-of-view motion 128 to the apparent motion). The corrected motion may be approximately equal to (or yield an estimate of) object motion 124.

In another example, knowledge of field-of-view motion 128 may be utilized to facilitate tracking of object 102. An assumed (e.g. stationary (zero) or another assumed value) or previously determined (e.g. from previous tracking of object 102) value of object motion 124, may be combined with knowledge of field-of-view motion 128 to calculate a position of a tracking region 138 within frame 130. For example, field-of-view motion 128 may be subtracted from the value of object motion 124 to estimate an apparent object position 112″ of object 102 within field of view 126. The estimated apparent object position 112″ may be used to estimate a new object image position 132″ of object image 132 within frame 130. Tracking region 138 (e.g. a center point of tracking region 138) may be placed located at or near an estimated object image position 132″. Tracking region 138 may thus be selected such that a new object image has a (e.g. predetermined) likelihood to be located within tracking region 138. For example, boundaries of tracking region 138 may be selected to be large enough to accommodate expected or reasonable errors in calculating apparent object position 112″ or an estimated object image position 132″.

Selection of a tracking region 138 may be utilized to facilitate tracking of object 102. A search for object image 132 at a new object image position 132″ within frame 130 may be initially limited to tracking region 138. Thus, if the new object image position 132″ is in fact located within tracking region 138 as expected, the new object image position 132″ may be found without expending computing time or resources to search the entire frame 130. In the case that the new object image position 132″ is not located within tracking region 138, the entire frame 130 may then be searched.

In another example, detection of a large or sudden field-of-view motion 128 (e.g. as determined by comparison of a measured value of field-of-view motion 128 with a threshold value or range) may cause rejection of any previous tracking of object 102, or any previous estimates of apparent object position 112″ or of object image position 132″. Tracking may thus be reinitialized (e.g. by searching for object image 132 within the entire frame 130).

In particular, data from a motion sensor 116 (e.g. one or more gyroscopes, compasses, or tilt sensors—multiple sensors having at least some of their axes oriented in different directions) may be analyzed to determine a rotation of imaging device 104, and thus of field of view 126. For example, a sensed rotation from a rotation sensor may, in some cases, be sufficiently accurate in order to be applied in determining object motion 124. Linear motion sensors, e.g. linear accelerometers, may not be included among motion sensors 116, or their accuracies may not be sufficient to enable quantitative calculations or corrections. An orientation of imaging device 104, tracking device 100, or of field of view 126 may be described, for example, using an Euler angle convention.

A current position and location of a body (e.g. device or field of view) may be described by up to six parameters or degrees of freedom. Three parameters may describe the position of the device on a Cartesian coordinate system (e.g. x, y, and z). A current orientation may be described by reference to three Euler angles.

A rotation sensor may sense a change in orientation. A rate of change in orientation along a single axis (e.g. of a spherical coordinate system or of an Euler angle) may be expressed as an angular frequency ωᵢ. An angle of rotation may be calculated from the corresponding sensed angular frequency and the time between two successive samples, Δt, in accordance with the following formula, where ΔΘ is the angle of rotation:

$$Δ Θ = \frac{( {ω}_{new} + {ω}_{old} )}{2} \cdot Δ t$$

The subscripts old and new represent the measured angular frequencies ωᵢ at the beginning and end, respectively, of the time interval Δt.

The calculated change in angle, if sufficiently accurate, may be used to adjust an estimated position of the tracked object (e.g. estimated on the assumption that the tracked object is stationary). Such an adjustment may eliminate or reduce the effect of a movement of the tracking device on tracking of the object. The (actual) movement of the tracked object is thus calculated on the basis of its current tracked position (e.g. apparent position as determined from imaging) relative to its estimated position.

For example, the following formula may be used to estimate a movement (in pixels) of a position the object image on an acquired frame after rotation through angle ΔΘ (about a single axis) of the imaging device (which is assumed to be located close to the rotation sensor, and to be aimed approximately at the tracked object such that the image plane is approximately perpendicular to the line of sight):

$$movement = ( \frac{tan Δ Θ * n}{2 * tan ( \frac{FOV}{2} )} )$$

where n is the number of pixels in the acquired frame as measured parallel to the direction of rotation, and FOV is the full angular size of the field of view of the imaging device. For rotation along two dimensions (e.g. one parallel to the height and the other to the width of the acquired frame), each component of the movement may be calculated separately and the results combined by vector addition.

When the imaging device is not located at the origin of rotation (e.g. imaging device is located at a significant distance r from the rotation sensor, relative to the distance d from the imaging device to the tracked object), the movement may be calculated as follows (again for rotation about a single axis):

$$movement = \frac{tan Δ Θ * n}{2 * tan ( \frac{FOV}{2} )} + \frac{r * ( 1 - cos Δ Θ ) * n}{2 * tan ( \frac{FOV}{2} ) * d}$$

Again, if the sensed rotation is along two axes, vector addition may be used to calculate a total movement of the object image in the image.

In some cases, the values that are generated by a rotation sensor or other motion sensor of the tracking device are not accurate enough to enable accurate calculation of a position of the tracked object. However, the values may be sufficiently accurate to yield an estimate of a new apparent position of the object image. In this case, a search window or tracking region may be positioned at the estimated position, and that search region may be searched for the tracked object. If the object is found in the tracking region, tracking may continue with the next acquired frame.

A change in linear acceleration may be detected by a linear accelerometer. Three mutually orthogonally arranged linear accelerometers may sense linear accelerations along three orthogonal axes. In some cases, linear accelerometer measurements may not be sufficiently accurate to enable accurate calculation of a change in relative position between the imaging device and the tracked object. In this case, linear accelerometer data may be used to detect motion that may interfere with tracking. However, the data may not be sufficiently accurate to assist in tracking (e.g. by enabling a prediction of an apparent position of the object). Therefore, if such acceleration is detected, the tracking process may be paused while the object image is searched for in acquired frames. In some cases, linear accelerometer may be sufficiently accurate to enable calculation of a general region of the acquired frame in which to search for the object image, or of an estimated apparent size (or range of sizes) of the object. Such a calculation may expedite detection of the object image. If a small movement is sensed, a size of a tracking region may be temporarily increased to increase the likelihood of detecting the object image in the tracking region. A frame that is acquired concurrently with, or immediately following, a detected movement may be excluded from use in the tracking process.

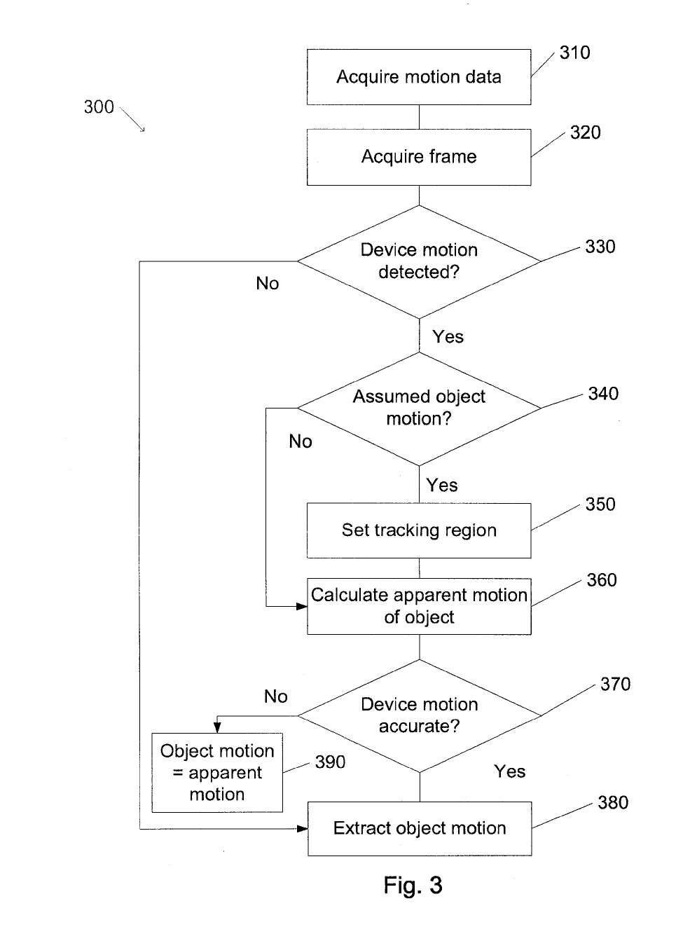

FIG. 3 is a flowchart of a tracking method, in accordance with some embodiments of the present invention. Tracking method 300 may be executed by a processor of a tracking device that includes an imaging device and a motion sensor. Tracking method 300 may be executed periodically at fixed intervals, at intervals that are adjustable (e.g. frequency of execution increases when tracked velocity of object or sensed motion of the tracking device increases), or in response to one or more events, such as for example a detected movement in a motion sensor that is associated with an imager.

It should be noted in connection with the flowchart that the division of the illustrated method into discrete operations, represented by blocks of the flowchart, is for convenience only. Alternate division of the illustrated method into discrete operations is possible. Any such alternate division should be understood as representing a method that is within the scope of embodiments of the present invention.

It should also be noted that, unless indicated otherwise, the depicted order of operations of the illustrated method as represented by blocks of the flowchart, is selected for convenience only. Execution of operations of the depicted method in an alternative order, or concurrently, is possible within the scope of embodiments of the present invention.

Data related to motion of the tracking device, or of the imaging device, may be acquired from one or more motion sensors (block 310). The acquired data may relate to a rotation or a linear motion of the imaging device or a combination of such motions.

A frame of image data may be acquired from an imaging device of the tracking device (block 320).

If the acquired motion data indicates motion (block 330), the motion data may be incorporated into the tracking process (continuing with block 340). Otherwise, the object image may be detected in the acquired image data, and the object motion extracted from detected changes in the position of the object image relative to the acquired frame (skipping to block 380).

In some cases, a motion of the tracked object may be assumed (block 340). For example, a previous motion of the tracked object may have been calculated during previous executions of tracking method 300 or another tracking method. Such a previous motion may, under some circumstances, be expected to continue. The tracked object may be assumed to be approximately stationary, or to be moving with an assumed motion.

If an object motion may be assumed, the previous motion and the detected motion of the tracking device may be combined so as to set a tracking region within the acquired frame (block 350). The tracking region may be utilized to expedite detection of the object image within the acquired frame.

If no object motion may be assumed, execution of tracking method 300 may continue without setting a tracking region (skipping to block 360). In other cases, execution of tracking method 300 may be terminated, paused, or restarted.

An apparent motion of the tracked object may be calculated based on motion of the object image in the acquired frame (block 360) or based on a detected motion from a sensor that is associated with the imager. If the imaging device had been in motion when the most recent images were acquired, the apparent motion of the tracked object may result from combined motion of the tracked object and of the field of view of the imaging device.

The sensed motion of the imaging device may be sufficiently accurate (block 370) to enable extracting a motion of the identified object from the apparent motion (block 380). If not, the object motion may be assumed to be equal to the apparent motion (block 390). In other cases, execution of tracking method 300 may be terminated, paused, or restarted without calculation of an object motion.

Execution of tracking method 300 may be repeated at a later time, or in response to a later triggering event.

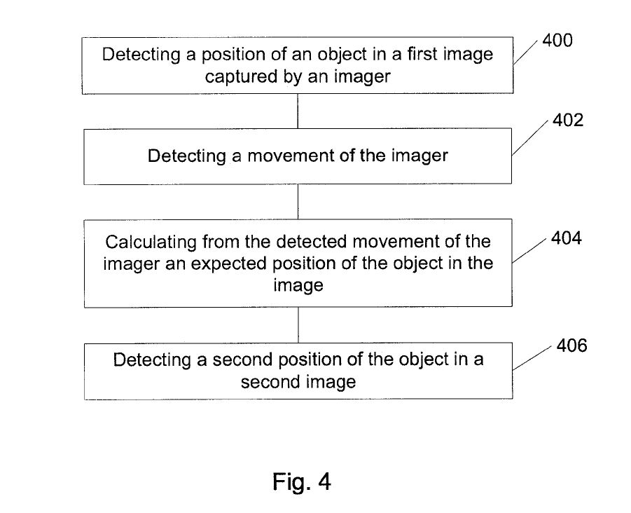

Reference is made to FIG. 4, a method of determining a cause of a movement of a position of an object in a series of images in accordance with an embodiment of the invention. Some embodiments may include a method of distinguishing, differentiating or determining an extent to which a cause of a change in a position of an object in an image or series of images resulted from a movement or change in a position of the imager capturing the images, or resulted from a movement of the tracked object in space. In block 400, a method of an embodiment may include detecting a first position of an object in a first of a series of images captured with an imager. In block 402, a movement of the imager may be detected by for example a motion sensor associated with the imager. In block 404, a calculation may be made of an expected change in a position of the object that resulted or would have resulted from the detected movement of the imager, such that an expected position of the object in a subsequent image may be derived. In some embodiments, an expected position may account for both a movement of the imager and for as assumed movement of the object being tracked in the series of images. Such assumed movement may be based, for example a velocity, direction or acceleration of the object from prior images. In block 406, the method may include detecting a second position of the object in a second image that may have been captured after the movement of the imager was detected. In some embodiments, the second image may have been captured when a detected movement of the imager has decreased below a pre-defined threshold level. For example, it may be advantageous to suspend or ignore tracking efforts during a period when there is a detected movement of the imager. Such detection or tracking during a detected movement of the imager may take up processing power and delay a re-initiation of tracking at a later desired point when an expected position of the object in a later frame can be predicted based on the total movement of the imager. In some embodiments, the calculation of the expected change in location may be delayed and applied to an image that is captured after a detected movement of the imager has decreased below a pre-defined threshold level.

In some embodiments a method may continue to compare the expected position of the object to the actual position of the object in the second image and to calculate a difference between the expected position and the actual position in the second image. A difference between the expected position and the actual position in the second image may be an indication that the object has moved in space between the two images. In some embodiments, a distance of a movement of the object between the two images may be calculated based on the position of the object in the second image relative to the expected position.

In some embodiments, a method may continue to altering a size or position of a search window in the second image to an area surrounding, at, matching or near the expected position of the object.

A method for suspending implementation of a function, said function to be implemented upon a detection of a change in a position of an object in an image, comprising:

Embodiments of the invention may include a method for suspending implementation of a function or calculation, where the function or calculation would have been implemented upon a detection of a change in a position of an object in an image. Embodiments of such method may include detecting a change of a location of an object in a series of images, such as between a location of the object in a first image in a series an the location of the object in a second image of the series. A method may detect a movement of an imager that was used to capturing the series of images, and where the detected movement occurred at a time of capture of one or more of the images in the series of images. The method may include suspending implementation of a calculation or function that would have been implemented or trigger upon the detection of the movement of the object in the series of images.

It will be appreciated by persons skilled in the art that embodiments of the invention are not limited by what has been particularly shown and described hereinabove. Rather the scope of at least one embodiment of the invention is defined by the claims below.

1. A method of identifying a cause of a change of a location of an object in a series of images, said series of images captured with an imager, comprising:
detecting a first position of said object in a first of said series of images;
detecting a movement of said imager;
calculating from said detected movement of said imager, an expected position of said object in said second of said series of images; and
detecting a second position of said object in a second of said series of images.

2. The method as in claim 1, comprising:
comparing said expected position of said object to said detected position of said object in said second of said series of images; and
calculating a difference between said detected second position and said expected position.

3. The method as in claim 2, comprising calculating a movement in space of said object between a time of capture of said first image and a time of capture of said second image.

4. The method as in claim 1, comprising moving a search window in said second of said series of images to said expected position of said object.

5. The method as in claim 1, wherein said calculating said expected position comprises calculating said position from said detected movement and from a movement of said object in a series of images prior to said series of images.

6. The method as in claim 1, wherein detecting said movement of said imager comprises receiving a signal from a motion sensor associated with said imager.

7. The method as in claim 1, wherein said calculating said expected position of said object comprises, calculating said expected position from said detected movement along Cartesian coordinates and along Eular angles.

8. The method as in claim 1, wherein said detecting said second position of said object, comprises detecting said position of said object in said second of said series of images, wherein said second of said series of images is captured when said detected movement of said imager is below a pre-defined threshold.

9. The method as in claim 1, comprising initiating an identification process of said object in said second image.

10. The method as in claim 1, wherein said detecting said movement of said sensor comprises detecting a magnitude of said movement that is above a pre-defined threshold.

11. The method as in claim 1, wherein said detecting comprises detecting a position of an eye of a user, and comprising capturing an image of said eye with an imager held by said user.

12. A system comprising:
an imager, configured to capture a series of images
a movement sensor configured to detected a direction and magnitude of a movement of said imager
a processor, configured to
identify a position of an object in a first image of said series of images
accept a signal from said sensor, said signal including a direction and magnitude of a movement of said imager; and
calculate, from said signal, an expected position of said object in a second of said series of images.

13. The system as in claim 12, wherein said processor is to identify a position of said object in said second of said series of images and compare said position with said expected position.

14. The system as in claim 12, wherein movement sensor comprises a movement sensor configured to detect said movement of said imager along Cartesian coordinates and along Eular coordinates.

15. A method of detecting a movement of a body part in an image, said image captured by an operator of an imager capturing said image, comprising:
capturing a series of images of body part of an operator of an imager capturing said series of images;
detecting in a first of said series of images a location of said body part,
detecting a movement of said imager;
calculating, from said movement of said imager, an expected position of said body part in a second image in said series of images;
calculating from an actual position of said body part in said second image, a movement of said body part between a capture of said first image and a capture of said second image.

16. The method as in claim 15, wherein said detecting a movement of said imager comprises, accepting a signal from a motion sensor connected to said imager, of a movement of said imager, said movement in excess of a pre-defined threshold.

17. The method as in claim 15, wherein said detecting a movement of said imager comprises, detecting a direction and magnitude of said movement said imager along Cartesian coordinates and along Eular coordinates.

18. The method as in claim 15, wherein said capturing a series of images of body part of an operator of an imager capturing said series of images; comprises capturing an image of an eye of said operator; and wherein detecting in a first of said series of images a location of said body part, comprises detecting a location of said eye.

19. A method for suspending implementation of a function, said function to be implemented upon a detection of a change in a position of an object in an image, comprising:
detecting said change of said location of said object between a location in a first image of a series of images, and a location in a second image of said series of images;
detecting a movement of an imager, said imager capturing said series of images, said detected image occurring at a time of capture of one of said first images and said second images; and
suspending implementation of a calculation, said implementation of said calculation triggered by said detecting said change of said location of said object.
